(19) United States
(12) Patent Application Publication
(10) Pub. No.: US 2010/0210467 A1
(43) Pub. Date: Aug. 19, 2010

(54) AGENT FOR IMPROVING SUGARCANE BRIX AND METHOD OF PROMOTING SUGARCANE RIPENING USING THE SAME

(75) Inventors: Masanori Kobayashi, Tokyo (JP); Shuji Ohno, Tokyo (JP); Yoshihiro Yamaji, Tokyo (JP); Ryo Hanai, Tokyo (JP); Jose Antonio De Souza Junior, Sao Paulo (BR); Helio Massatoshi Tukamoto, Sao Paulo (BR)

Correspondence Address: WENDEROTH, LIND & PONACK, L.L.P., 1030 15th Street, N.W.,, Suite 400 East, Washington, DC, 20005-1503, US

(73) Assignee: Kumiai Chemical Industry Co., Ltd.

(21) Appl. No.: 12/734,100

(22) PCT Filed: Oct. 24, 2008
(86) PCT No.: PCT/JP2008/069299

§ 371 Date: Apr. 9, 2010

(30) Foreign Application Priority Data
Oct. 26, 2007 (JP) 2007-279429

(51) Int. Cl. A01N 43/54; C07D 403/12; C07D 239/46; C07D 405/12; A01P 21/00

(52) U.S. Cl. 504/239; 544/296; 544/302; 544/301; 544/319; 544/300

(57) ABSTRACT

It is intended to provide an agent for improving sugarcane Brix which increases the sugar productivity from pressed juice after harvesting and promotes ripening when applied to sugarcane and, therefore, by which a sugar yield comparable to sugarcane harvested at the best harvest season can be established even from sugarcane before reaching the harvest season, which comprises at least one member of the compounds represented by the following general formula (I)

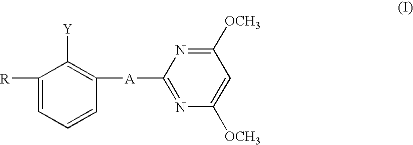

wherein A represents an oxygen atom, a sulfur atom, or a hydroxymethylene group; Y represents a carboxyl group, an alkyloxycarbonyl group, a halogenated methylsulfonylamino group or a diphenylmethylideneiminoxycarbonyl group, either in a free form or forming a salt; and R represents a halogen atom, an alkyl group, a hydroxy-, alkoxy- or alkoxyiminoalkyl group or a 4,6-dimethoxypyrimidin-2-yloxy group, or Y and R may be bonded together to form a group —C(═O)—O—CH(CH₃)—.

### TECHNICAL FIELD

The present invention relates to an agent for increasing the sugar content for promoting accumulation of sugar in sugarcane stem, i.e. parenchyma cells in sugarcane stem, as well as a method for accumulating sugar in stem of sugarcane, or the so-called method of accelerating ripening of sugarcane using the agent.

### BACKGROUND ART

In a broad stretch of sugarcane cultivated area, large-scale treating facilities are usually installed for sugar refining treatment after harvesting of ripened sugarcane. In order to operate such treating facilities efficiently, it is necessary to collect the ripened sugarcane as much as possible to the utmost operation limit of the treating capacity and to consider a plan for the treatment so as not to occur rest time of the facilities.

In a broad stretch of the cultivation area, however, time lag takes place in the harvesttime so that the ratio of ripened sugarcanes is not necessarily definite. It is therefore necessary to accelerate ripening of sugarcane in the unripened area in order to ensure keeping of the material of the desired amount.

A research for agents of increasing the sugar content for accelerating ripening of sugarcane has thus been made and several agents for increasing the sugar content have been proposed hitherto.

A plant growth retardant is known to have an effect of artificially accelerating ripening of sugarcane so that the harvesttime can artificially be controlled to enhance the commercial cane sugar (CCS) value [“Zucker”, Vol. 7 (1954), p. 329)]. Several plant growth regulators using glyphosate, one of the plant growth retardants, as a basic agent, are heretofore proposed [“H. I. Sugar Techgts Rept.” Vol. 30 (1977), pp. 63-66].

It is also known that a cyclohexanedione-based compound which is one of the plant growth retardants is effective for enhancing Brix in the stems of sugarcane [“Tropical Agriculture” Vol. 34, No. 4 (1990), pp. 260-264].

In Brazil, the largest country in the world of producing sugarcane, ethephon, sulfometuron-methyl, glyphosate, fluazifop, trinexapac-ethyl etc. are used for the purpose of increasing the sugar content of sugarcane.

The agents for increasing sugar content used hitherto are, however, inferior in sugar-increasing effect and have failed to accelerate ripening sufficiently.

### DISCLOSURE OF THE INVENTION

The present invention relates to an agent for increasing the sugar content of sugarcane, which is capable of, by being applied to sugarcane, increasing sugar production amount from a juice of sugarcane after harvest and, in addition, by being applied to sugarcane not yet ripened enough to harvest, accelerating ripening of the sugarcane so as to enable obtaining the same sugar yield from sugarcane as that of sugarcane ripened enough to harvest, as well as a method for accelerating ripening of sugarcane by using the agent.

As a result of extensive research for developing an agent for increasing the sugar content capable of efficiently accelerating ripening of sugarcane, it has been found by the inventors that specific pyrimidine compounds among the compounds hitherto used as a herbicide exhibit strong ripening-accelerating effects on sugarcane. The present invention has been accomplished on the basis of the above finding.

In accordance with the present invention, namely, there is provided an agent for increasing the sugar content of sugarcane, which comprises at least one compound represented by the general formula,

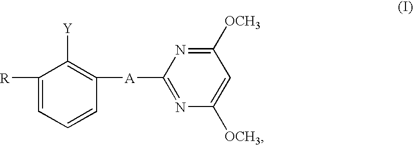

wherein A denotes an oxygen atom, sulfur atom, or hydroxymethylene group; Y denotes a free type or salt type carboxyl group, alkyloxycarbonyl group, halogenated methylsulfonylamino group or diphenylmethylideneiminoxycarbonyl group; R denotes a halogen atom, alkyl group, hydroxy-, alkoxy or alkoxyimino alkyl group or 4,6-dimethoxypyrimidin-2-yloxy group, and Y and R may be optionally bonded each other to form a group of —C(═O)—O—CH(CH₃)—, as well as a method for accelerating ripening of sugarcane, which comprises applying the aforementioned sugar-content increasing agent to sugarcane under cultivation 15-60 days before the harvesttime or at the time when the concentration of a soluble solid matter (Brix) in a juice of the stem reaches 80-90% of an average Brix value of sugarcane in the harvesttime.

In the general formula (I), A denotes an oxygen atom, sulfur atom or alternatively hydroxymethylene group shown by —CH(OH)—. Y denotes a free type or salt type carboxyl group shown by —COOM, wherein M denotes H; an alkali metal such as Na or K; alkaline earth metal in the monovalent form such as ½ Mg, ½Ca, or ½Ba; ammonium or quaternary ammonium ion shown by the general formula,

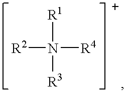

wherein each of R¹, R², R³ and R⁴ is, independently from the others, a hydrogen atom, alkyl group, phenyl group or alkyl or phenyl group substituted by a halogen atom, hydroxyl group or alkoxyl group; alkyloxycarbonyl group represented by the general formula, —COOR^{S}, wherein R⁵ denotes an alkyl group; or halogenated methylsulfonylamino group shown by the general formula, —HNSO₂—CX₃—, wherein at least one of the X is a halogen atom and the rest is a hydrogen atom. The aforementioned alkyl group is preferably a lower alkyl group, i.e. alkyl group having 1-6 carbon atoms.

R is a halogen atom such as chlorine atom or bromine atom, or straightly linear or branched alkyl group having 1-6 carbon atoms such as methyl, ethyl, propyl, butyl, pentyl or hexyl group. R also includes an alkyl group having a hydroxyl, alkoxyl or alkoxyimino group and 4,6-dimethoxypyrimidin-2-yloxy group. It is preferable that the aforementioned hydroxyl, alkoxyl or alkoxyimino group is substituted in 1-position of the alkyl group. 1-Alkoxyiminoalkyl group is exemplified by 1-methoxyiminoethyl group. In case the alkyl group has a hydroxyl group in 1-position thereof, it may optionally form a group of —C(═O)—O—CH(CH₃)—, i.e. a lactone ring, together with the carboxyl group of Y.

The preferable compounds shown by the general formula (I) are, for example,

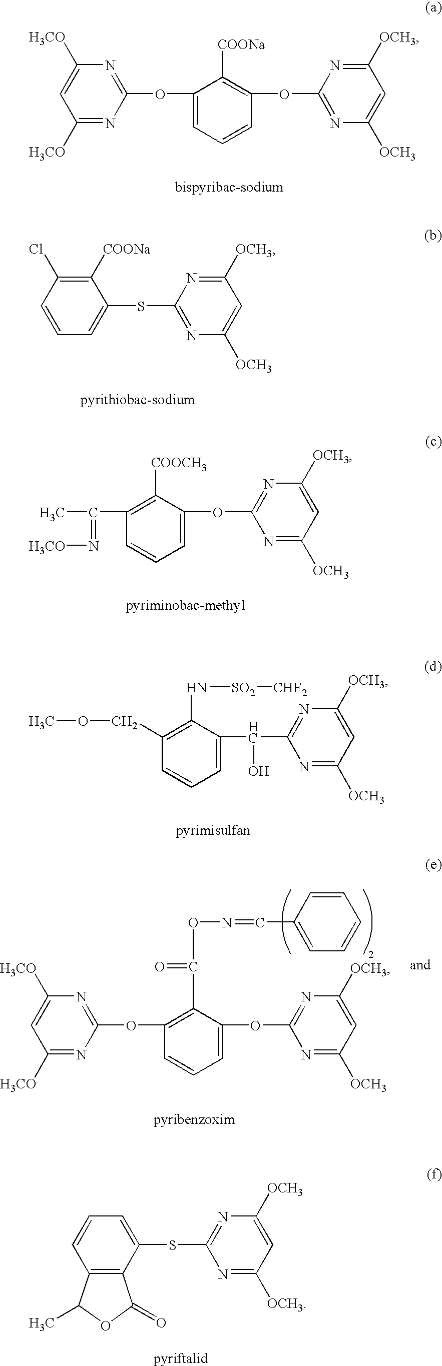

The above-given compounds (a)-(f) are known compounds disclosed as a herbicide in JP1-230561A, JP1-250365A, JP4-134073A, JP2000-44546A, WO91/5781A, and EP658549A.

Bispyribac-sodium, pyrithiobac-sodium, pyriminobac-methyl, pyribenzoxim, and pyriftalid are commercially available and can be obtained easily.

The agent for increasing the sugar content of the present invention exhibits excellent sugar content-increasing effect by using at least one of the compounds represented by the general formula (I) as the effective ingredient. However, the sugar content-increasing effect can further be enhanced by conjoint use of at least one compound selected from prohexadione, trinexapac-ethyl, gibberellins and ethephon and salts thereof, chlormequat, and mepiquat chloride. Among these compounds, prohexadione-calcium, trinexapac-ethyl and gibberellins are preferable. Incidentally, these compounds are well known as agricultural and horticultural pesticides and readily available.

The agent for increasing the sugar content of the present invention is applied to sugarcane under cultivation in a dose of 1-1000 g, preferably, 5-200 g or, more preferably, 20-40 g per hectare. In case prohexadione-calcium or trinexapac-ethyl is admixed with the agent, prohexadione-calcium or trinexapac-ethyl is added in a dose of 10-1000 g, preferably, 50-500 g or, more preferably, 100-300 g to 5-200 g of the compound shown by the above-given general formula (I) per hectare. In case gibberellin is admixed with the agent, gibberellin is admixed with the agent in a dose of 0.1-1000 g, preferably, 1-100 g or, more preferably, 5-30 g to 5-200 g of the compound shown by the above-given general formula (I) per hectare.

The agent for increasing the sugar content of the present invention can be used in mixture with one or more of plant growth regulators, insecticides, acaricides, nematocides, fungicides, microbial agents, fertilizers, spreaders, and other additives conventionally employed with pesticides. The agent can be incorporated, if necessary, with a surfactant or excipient and applied as prepared in any formulations such as granules, dust formulations, wettable powders, suspension concentrates, emulsifiable concentrates, and paste formulations, etc.

Solid carriers used for these formulations are, for example, kaolin, diatomaceous earth, synthetic hydrous silicon dioxide, Fubasami clay, bentonite, acid clay, talc, cericite, quartz powder, powdery sulfur, activated carbon, calcium carbonate, and hydrated silica. In addition thereto, fine powders or granules of chemical fertilizers such as ammonium sulfate, ammonium phosphate, ammonium nitrate, urea and ammonium chloride, etc. can also be used as carrier.

Utilizable as liquid carriers are water, alcohols such as methanol and ethanol, etc., ketones such as acetone and methyl ethyl ketone, etc., aromatic hydrocarbons such as benzene, toluene, xylene, ethylbenzene and methylnaphthalene, etc., aliphatic hydrocarbons such as n-hexane, cyclohexanone and kerosenes, etc., esters such as ethyl acetate and butyl acetate, etc., nitriles such as acetonitrile and isobutyronitrile, etc., ethers such as dioxine and diisopropyl ether, etc., acid amides such as dimethylformamide and dimethylacetamide, etc., halogenated hydrocarbons such as dichloroethane, trichloroethylene and carbon tetrachloride, etc.

Surfactants used for the formulations of the inventive agent for increasing the sugar content are exemplified, for example, by alkylsulfate esters, alkylsulfonate salts, alkylarylsulfonate salts, alkylaryl ethers and polyoxyethylenated products thereof, polyethyleneglycol ethers, polyhydric alcohol esters, and sugar alcohol derivatives, etc.

Binders used for the agent for increasing the sugar content of the present invention are exemplified, for example, by casein; gelatin; polysaccharides such as starch powder, gum arabic, cellulose derivatives and arginic acid; lignin derivatives; bentonite; and synthetic water-soluble high molecular compounds such as polyvinyl alcohol, polyvinyl pyrrolidone, and polyacrylic acid.

The agent for increasing the sugar content of sugarcane of the present invention is used in the form of a powder formulation being carried on the aforementioned solid carrier or a liquid formulation being dissolved in the aforementioned liquid carrier, as such or after diluted to a desired concentration. In case of the liquid formulations, it is preferable to select the concentration so that the formulations can be sprayed at a rate of 1-10000 liters per hectare.

The agent for increasing the sugar content of sugarcane of the present invention is applied by way of uniform spraying 15-60 days before the harvesttime when the agent for increasing the sugar content of the present invention is not used. Ripening of sugarcane can be investigated by extracting a juice from the middle of internodes of sugarcane stem and by measuring the concentration of a soluble solid matter (Brix) contained in the juice. In Brazil, it is standard of the harvesttime when a degree of Brix becomes at least 18%. Time for treatment with the agent for increasing the sugar content of sugarcane of the preset invention can be also determined by investigating the Brix value of sugarcane under cultivation, whereby the best time is when the Brix value thus investigated becomes 80-90% of the average Brix value of sugarcane in the harvesttime in the relevant area.

In case the compound represented by the above-given general formula (I) is applied for the purpose of agricultural herbicide, the compound is sprayed during the former half period of cultivation of sugarcane while, it is necessary to spray the agent for increasing the sugar content of the present invention during the latter half period of cultivation so that the use mode is manifestly different therebetween. Further, the dose of the agent is smaller as compared with the case of using it as herbicide.

In case bispyribac-sodium [the aforesaid compound (a)] is applied as a herbicide, for example, it is necessary to use the compound at a rate of 40-60 g/ha. Nevertheless, the compound can be used in a relatively small amount of 16-35 g/ha if it is used as an agent for increasing the sugar content. Further, the application time is a posterior period of cultivation so that the use mode is apparently different therebetween.

The agent for increasing the sugar content of sugarcane of the present invention can also be applied to crops transformed by way of gene recombination technology as in the case of naturally cultivated sugarcane.

### BEST MODE FOR CARRYING OUT THE INVENTION

The best mode for carrying out the present invention will now be illustrated by way of Examples. It is to be construed however that the present invention is not limited by these Examples.

### Example 1

With respect to sugarcane grown in a sugarcane cultivated area in Brazil (an average Brix value in the harvesttime being 18%), a juice was collected from 5 middle internodes selected at random in the sugarcane stem and the Brix value was measured according to a usual method. At the time the measured Brix value became 82% of the aforementioned average Brix value, a bispyribac-sodium formulation (a commercially available product, a tradename “NOMINEE 400SC”) was diluted with water so that the amount of the effective ingredient in 74 liters of the spraying liquid could be equal to the used amount shown in Table 1. The liquid was then sprayed above the plant by the aid of a power sprayer to a test area at a rate of 74 liters per hectare.

In a control area, a known sulfometuron-methyl formulation (a commercially available product, a tradename “CURAVIAL”) was similarly sprayed. In addition, a non-treated area was provided in the area apart from the test areas as far as the spraying liquids did not reach.

Next, 10 individual sugarcanes were cut from each area on the initial day of spraying, after 30 days of spraying and after 45 days of spraying, and thereafter the stem was squeezed and sugar was recovered from the juice to obtain the yield. Each yield was compared with the yield of the initial day of spraying and the rate of increase (%) was calculated. The result thereof is shown in Table 1 and Table 2.

In accordance with “NORMAS DE AVALIAçÃO DA QUALIDADE DA CANA-DE-AçÚCAR” used in Brazilian sugar refining plants as Standard for quality evaluation of sugarcane, the analysis on the sugar content in the squeezed juice of sugarcane stem was carried out for Brix value, sugar content in sugarcane (PC), and total sugar amount recoverable from sugarcane stem (ATR) as follows.

Brix was measured according to a digital refractometer. PC was calculated according to the equation (1). ATR was calculated according to the equation (5).

PC=S×(1−0.01×F)×C (1)

S denotes a sugar content in the extracted liquid and is calculated according to the equation (2). F denotes an amount of fibers in sugarcane and is calculated according to the equation (3). C denotes a conversion coefficient from the sugar content in the extracted liquid to an absolute amount and is calculated according to the equation (4).

S=(1.00621×LAI+0.05117)×(0.2605−0.0009882×Brix) (2)

LAI denotes a measured value by the digital saccharimeter after clarification of the juice by a clarifying mixture made from aluminum.

F=0.08×PBU+0.876 (3)

PBU denotes the mass of a wet bagasse exhausted from a pressing machine in the squeezed step of sugarcane stem.

C=1.0313−0.00575×F (4)

ATR=9.26288×PC+8.8×ARC (5)

ARC denotes an amount of reducing sugar of sugarcane and is calculated from the following equation (6).

ARC=AR×(1−0.01×F)×C (6)

AR denotes an amount of reducing sugar in the extracted liquid and is calculated from the following equation (7).

AR=3.641−0.0343×100×S/Brix (7)

TABLE 1

| | | | | | Yield after the lapse of 30 days | | |
|---|---|---|---|---|---|---|---|
| | | | | | (Parenthesized numerals shows an increased | | |
| | | Yield on the initial day of spraying | | | rate % from the initial day of spraying) | | |
| | Amount | Concentration of | Sugar content | Total sugar amount | Concentration of | Sugar content | Total sugar amount |
| | used | soluble solid | in sugarcane, | recoverable from 1 kg | soluble solid | in sugarcane, | recoverable from 1 kg |
| Compound | (g/ha) | matter, Brix (%) | PC (%) | of stem, ATR (g) | matter, Brix (%) | PC (%) | of stem, ATR (g) |
| Bispyribac- | 16 | 15.0 | 10.3 | 105.4 | 18.4 (23.0) | 13.0 (25.7) | 129.7 (23.1) |
| sodium | 35 | 15.8 | 10.8 | 109.9 | 20.5 (29.5) | 14.7 (35.9) | 145.1 (32.0) |
| Sulfometuron- | 15 | 15.8 | 11.2 | 113.3 | 19.2 (21.4) | 13.9 (24.3) | 138.1 (21.9) |
| methyl | | | | | | | |
| Control | — | 14.8 | 10.3 | 105.3 | 16.4 (10.5) | 11.8 (14.3) | 118.5 (12.5) |

TABLE 2

| | | Yield after the lapse of 45 days | | |
|---|---|---|---|---|
| | | (Parenthesized numerals shows an increased | | |
| | | rate % from the initial day of spraying) | | |
| | | | | Total sugar |
| | | Concentration | Sugar | amount |
| | Amount | of soluble | content in | recoverable from |
| Com- | used | solid matter, | sugarcane, | 1 kg of stem, |
| pound | (g/ha) | Brix (%) | PC (%) | ATR (g) |
| Bispyri- | 16 | 21.1 (41.0) | 15.5 (50.9) | 152.7 (44.9) |
| bac- | 35 | 21.7 (37.1) | 15.9 (47.6) | 156.2 (42.1) |
| sodium | | | | |
| Sulfo- | 15 | 20.5 (29.6) | 15.1 (35.1) | 148.7 (31.2) |
| meturon- | | | | |
| methyl | | | | |
| Control | — | 17.9 (20.4) | 12.5 (21.6) | 125.2 (18.9) |

### Example 2

At the time the Brix value of sugarcane grown in a sugarcane cultivated area in Brazil (an average Brix value in the harvesttime being 21%) became 81% of the aforesaid average Brix value, a bispyribac-sodium formulation (a commercially available product, a tradename “NOMINEE 400SC”) was diluted with water so that the amount of the effective ingredient in 30 liters of the spraying liquid could be equal to the used amount shown in Table 3, and the liquid was sprayed over the test area from an air-craft at a rate of 30 liters per hectare.

In a control area, a known fluazifop formulation (a commercially available product, a tradename “FUSILADE”) was similarly sprayed. In addition, a non-treated area was provided in the area apart from the test areas as far as the spraying liquids did not reach.

Next, 5 individual sugarcanes were cut from 5 locations in each area, i.e. 25 sugarcanes from each area, on the initial day of spraying and after 30 days of spraying, and thereafter the stems were squeezed and sugar was recovered from the juice to obtain the yield. The yield after 30 days of spraying was compared with the yield of the initial day of spraying and the rate of increase (%) was calculated. The result thereof is shown in Table 3. The analysis on the sugar content in the squeezed juice of sugarcane stems was carried out similarly as in the case of Example 1.

TABLE 3

| | | | | | Yield after the lapse of 30 days | | |
|---|---|---|---|---|---|---|---|
| | | | | | (Parenthesized numerals shows an increased | | |
| | | Yield on the initial day of spraying | | | rate % from the initial day of spraying) | | |
| | Amount | Concentration of | Sugar content | Total sugar amount | Concentration of | Sugar content | Total sugar amount |
| | used | soluble solid | in sugarcane, | recoverable from 1 kg | soluble solid | in sugarcane, | recoverable from 1 kg |
| Compound | (g/ha) | matter, Brix (%) | PC (%) | of stem, ATR (g) | matter, Brix (%) | PC (%) | of stem, ATR (g) |
| Bispyribac- | 25 | 16.6 | 11.8 | 115.9 | 19.9 (19.8) | 14.6 (24.1) | 141.8 (22.3) |
| sodium | 30 | 17.1 | 12.4 | 122.1 | 20.8 (21.6) | 15.6 (25.2) | 149.0 (22.1) |
| Fluazifop | 50 | 17.4 | 12.4 | 121.4 | 20.5 (18.1) | 15.1 (22.0) | 146.0 (20.2) |
| Control | — | 17.2 | 12.1 | 119.3 | 19.8 (15.4) | 14.5 (19.7) | 141.0 (18.2) |

### Example 3

At the time the Brix value of sugarcane grown in a sugarcane cultivated area in Brazil (an average Brix value in the harvesttime being 18%) became 88% of the aforesaid average Brix value, pyrimisulfan (pyrimisulfan prepared by a method disclosed in JP2000-44546A) was diluted with water so that the amount of the effective ingredient in 105 liters of the spraying liquid could be equal to the used amount shown in Table 4, and the liquid was sprayed above the plant by the aid of a CO₂-pressurized back pack sprayer to the test area at a rate of 105 liters per hectare.

In a control area, a known sulfometuron-methyl formulation (a commercially available product, a tradename “CURAVIAL”) was similarly sprayed. In addition, a non-treated area was provided in the area apart from the test areas as far as the spraying liquids did not reach.

Next, 20 individual sugarcanes were cut from each area on the initial day of spraying, after 15 days of spraying, after 30 days of spraying and after 45 days of spraying, and thereafter the stems were squeezed and sugar was recovered from the juice to obtain the yield. Each yield was compared with the yield of the initial day of spraying and the rate of increase (%) was calculated. The result thereof is shown in Table 4 and Table 5. The analysis on the sugar content in the squeezed juice of sugarcane stems was carried out similarly as in the case of Example 1.

TABLE 4

| | | | | Yield after the lapse of 15 days | |
|---|---|---|---|---|---|
| | | | | (Parenthesized numerals shows an increased | |
| | | Yield on the initial day of spraying | | rate % from the initial day of spraying) | |
| | Amount | Concentration of | Total sugar amount | Concentration of | Total sugar amount |
| | used | soluble solid | recoverable from 1 kg | soluble solid | recoverable from 1 kg |
| Compound | (g/ha) | matter, Brix (%) | of stem, ATR (g) | matter, Brix (%) | of stem, ATR (g) |
| Pyrimisulfan | 40 | 16.4 | 113.8 | 17.4 (5.8) | 120.1 (5.5) |
| Sulfometuron- | 15 | 16.5 | 115.1 | 16.7 (1.2) | 117.0 (1.7) |
| methyl | | | | | |
| Control | — | 15.9 | 109.4 | 15.9 (0.0) | 112.5 (2.8) |

TABLE 5

| | | Yield after the lapse of 30 days | | Yield after the lapse of 45 days | |
|---|---|---|---|---|---|
| | | (Parenthesized numerals shows an increased | | (Parenthesized numerals shows an increased | |
| | | rate % from the initial day of spraying) | | rate % from the initial day of spraying) | |
| | Amount | Concentration of | Total sugar amount | Concentration of | Total sugar amount |
| | used | soluble solid | recoverable from 1 kg | soluble solid | recoverable from 1 kg |
| Compound | (g/ha) | matter, Brix (%) | of stem, ATR (g) | matter, Brix (%) | of stem, ATR (g) |
| Pyrimisulfan | 40 | 17.7 (7.6) | 124.6 (9.5) | 17.8 (8.2) | 128.1 (12.6) |
| Sulfometuron- | 15 | 17.6 (6.4) | 124.5 (8.1) | 16.2 (−1.8) | 114.4 (−0.6) |
| methyl | | | | | |
| Control | — | 16.6 (4.1) | 117.2 (7.1) | 17.0 (6.9) | 122.0 (11.5) |

### Example 4

At the time the Brix value of sugarcane grown in a sugarcane cultivated area in Brazil (an average Brix value in the harvesttime being 20%) became 86% of the aforesaid average Brix value, a pyribenzoxim formulation (a tradename “PYANCHOR”) was diluted with water so that the amount of the effective ingredient in 105 liters of the spraying liquid could be equal to the used amount shown in Table 6, and the liquid was sprayed above the plant by the aid of a CO₂-pressurized back pack sprayer to the test area at a rate of 105 liters per hectare.

In a control area, a known sulfometuron-methyl formulation (a commercially available product, a tradename “CURAVIAL”) was similarly sprayed. In addition, a non-treated area was provided in the area apart from the test areas as far as the spraying liquids did not reach.

Next, 20 individual sugarcanes were cut from each area on the initial day of spraying, after 15 days of spraying, after 30 days of spraying and after 45 days of spraying, and thereafter the stems were squeezed and sugar was recovered from the juice to obtain the yield. Each yield was compared with the yield of the initial day of spraying and the rate of increase (%) was calculated. The result thereof is shown in Table 6 and Table 7. The analysis on the sugar content in the squeezed juice of sugarcane stems was carried out similarly as in the case of Example 1.

TABLE 6

| | | | | Yield after the lapse of 15 days | |
|---|---|---|---|---|---|
| | | | | (Parenthesized numerals shows an increased | |
| | | Yield on the initial day of spraying | | rate % from the initial day of spraying) | |
| | Amount | Concentration of | Total sugar amount | Concentration of | Total sugar amount |
| | used | soluble solid | recoverable from 1 kg | soluble solid | recoverable from 1 kg |
| Compound | (g/ha) | matter, Brix (%) | of stem, ATR (g) | matter, Brix (%) | of stem, ATR (g) |
| Pyribenzoxim | 40 | 16.0 | 112.2 | 17.8 (10.9) | 128.1 (14.2) |
| Sulfometuron- | 15 | 17.5 | 124.0 | 16.5 (−5.4) | 120.1 (−3.2) |
| methyl | | | | | |
| Control | — | 17.1 | 122.6 | 17.2 (0.6) | 122.2 (−0.3) |

TABLE 7

| | | Yield after the lapse of 30 days | | Yield after the lapse of 45 days | |
|---|---|---|---|---|---|
| | | (Parenthesized numerals shows an increased | | (Parenthesized numerals shows an increased | |
| | | rate % from the initial day of spraying) | | rate % from the initial day of spraying) | |
| | Amount | Concentration of | Total sugar amount | Concentration of | Total sugar amount |
| | used | soluble solid | recoverable from 1 kg | soluble solid | recoverable from 1 kg |
| Compound | (g/ha) | matter, Brix (%) | of stem, ATR (g) | matter, Brix (%) | of stem, ATR (g) |
| Pyribenzoxim | 40 | 17.5 (9.1) | 123.6 (10.2) | 19.2 (19.7) | 136.8 (22.0) |
| Sulfometuron- | 15 | 19.1 (9.2) | 136.3 (9.9) | 20.5 (17.2) | 147.6 (19.0) |
| methyl | | | | | |
| Control | — | 18.8 (9.6) | 134.7 (9.8) | 19.4 (13.2) | 137.9 (12.4) |

### Example 5

At the time the Brix value of sugarcane grown in a sugarcane cultivated area in Brazil (an average Brix value in the harvesttime being 18%) became 88% of the aforesaid average Brix value, a bispyribac-sodium formulation (a commercially available product, a tradename, “NOMINEE 400SC”) and a gibberellin formulation (a commercially available product, a tradename, “PRO-GIBB”) were admixed together and diluted with water or separately diluted with water so that the amount of the effective ingredient in 105 liters of each of the spraying liquids could be equal to the used amount shown in Table 8, and each liquid was sprayed above the plant by the aid of a CO₂-pressurized back pack sprayer to the test area at a rate of 105 liters per hectare.

In a control area, a known sulfometuron-methyl formulation (a commercially available product, a tradename “CURAVIAL”) was similarly sprayed. In addition, a non-treated area was provided in the area apart from the test areas as far as the spraying liquids did not reach.

Next, 20 individual sugarcanes were cut from each area on the initial day of spraying, after 15 days of spraying, after 30 days of spraying and after 45 days of spraying, and thereafter the stems were squeezed and sugar was recovered from the juice to obtain the yield. Each yield was compared with the yield of the initial day of spraying and the rate of increase (%) was calculated. The result thereof is shown in Table 8 and Table 9. The analysis on the sugar content in the squeezed juice of sugarcane stems was carried out similarly as in the case of Example 1.

TABLE 8

| | | | | Yield after the lapse of 15 days | |
|---|---|---|---|---|---|
| | | | | (Parenthesized numerals shows an increased | |
| | | Yield on the initial day of spraying | | rate % from the initial day of spraying) | |
| | Amount | Concentration of | Total sugar amount | Concentration of | Total sugar amount |
| | used | soluble solid | recoverable from 1 kg | soluble solid | recoverable from 1 kg |
| Compound | (g/ha) | matter, Brix (%) | of stem, ATR (g) | matter, Brix (%) | of stem, ATR (g) |
| Bispyribac- | 20 + 10 | 15.1 | 104.0 | 17.0 (12.6) | 121.2 (16.5) |
| sodium + | | | | | |
| gibberellin | | | | | |
| Bispyribac- | 20 | 15.5 | 105.9 | 16.2 (4.5) | 112.5 (6.2) |
| sodium | | | | | |
| Gibberellin | 10 | 16.3 | 114.5 | 17.2 (5.5) | 120.5 (5.3) |
| Sulfometuron- | 15 | 16.5 | 115.1 | 16.7 (1.2) | 117.0 (1.7) |
| methyl | | | | | |
| Control | — | 15.9 | 109.4 | 15.9 (0.0) | 112.5 (2.8) |

TABLE 9

| | | Yield after the lapse of 30 days | | Yield after the lapse of 45 days | |
|---|---|---|---|---|---|
| | | (Parenthesized numerals shows an increased | | (Parenthesized numerals shows an increased | |
| | | rate % from the initial day of spraying) | | rate % from the initial day of spraying) | |
| | Amount | Concentration of | Total sugar amount | Concentration of | Total sugar amount |
| | used | soluble solid | recoverable from 1 kg | soluble solid | recoverable from 1 kg |
| Compound | (g/ha) | matter, Brix (%) | of stem, ATR (g) | matter, Brix (%) | of stem, ATR (g) |
| Bispyribac- | 20 + 10 | 17.5 (16.3) | 124.4 (19.6) | 17.6 (16.6) | 124.0 (19.2) |
| sodium + | | | | | |
| gibberellin | | | | | |
| Bispyribac- | 20 | 17.3 (11.7) | 124.2 (17.3) | 17.5 (12.9) | 126.1 (19.1) |
| sodium | | | | | |
| Gibberellin | 10 | 17.8 (8.9) | 127.9 (11.7) | 16.8 (3.1) | 118.8 (3.8) |
| Sulfometuron- | 15 | 17.6 (6.4) | 124.5 (8.1) | 16.2 (−1.8) | 114.4 (−0.6) |
| methyl | | | | | |
| Control | — | 16.6 (4.1) | 117.2 (7.1) | 17.0 (6.9) | 122.0 (11.5) |

### Example 6

At the time the Brix value of sugarcane grown in a sugarcane cultivated area in Brazil (an average Brix value in the harvesttime being 20%) became 80% of the aforesaid average Brix value, a bispyribac-sodium formulation (a commercially available product, a tradename, “NOMINEE 400SC”) and a prohexadione-calcium formulation (a tradename, “VIVIFUL”) were admixed together and diluted with water so that the amount of the effective ingredient in 105 liters of each spraying liquid could be equal to the used amount shown in Table 10, and the liquid was sprayed above the plant by the aid of a CO₂-pressurized back pack sprayer to the test area at a rate of 105 liters per hectare.

In a control area, a known trinexapac-ethyl formulation (a commercially available product, a tradename “MODDUS”) was similarly sprayed. In addition, a non-treated area was provided in the area apart from the test areas as far as the spraying liquids did not reach.

Next, 20 individual sugarcanes were cut from each area on the initial day of spraying, after 15 days of spraying, after 30 days of spraying and after 45 days of spraying, and thereafter the stems were squeezed and sugar was recovered from the juice to obtain the yield. Each yield was compared with the yield of the initial day of spraying and the rate of increase (%) was calculated. The result thereof is shown in Table 10 and Table 11. The analysis on the sugar content in the squeezed juice of sugarcane stems was carried out similarly as in the case of Example 1.

TABLE 10

| | | | | Yield after the lapse of 15 days | |
|---|---|---|---|---|---|
| | | | | (Parenthesized numerals shows an increased | |
| | | Yield on the initial day of spraying | | rate % from the initial day of spraying) | |
| | Amount | Concentration of | Total sugar amount | Concentration of | Total sugar amount |
| | used | soluble solid | recoverable from 1 kg | soluble solid | recoverable from 1 kg |
| Compound | (g/ha) | matter, Brix (%) | of stem, ATR (g) | matter, Brix (%) | of stem, ATR (g) |
| Bispyribac- | 20 + 110 | 16.2 | 114.1 | 17.7 (9.3) | 124.3 (9.0) |
| sodium + | | | | | |
| prohexadione- | | | | | |
| calcium | | | | | |
| Trinexapac- | 200 | 16.2 | 113.5 | 17.5 (8.0) | 125.3 (10.3) |
| ethyl | | | | | |
| Control | — | 15.9 | 111.3 | 17.0 (6.9) | 118.7 (6.7) |

TABLE 11

| | | Yield after the lapse of 30 days | | Yield after the lapse of 45 days | |
|---|---|---|---|---|---|
| | | (Parenthesized numerals shows an increased | | (Parenthesized numerals shows an increased | |
| | | rate % from the initial day of spraying) | | rate % from the initial day of spraying) | |
| | Amount | Concentration of | Total sugar amount | Concentration of | Total sugar amount |
| | used | soluble solid | recoverable from 1 kg | soluble solid | recoverable from 1 kg |
| Compound | (g/ha) | matter, Brix (%) | of stem, ATR (g) | matter, Brix (%) | of stem, ATR (g) |
| Bispyribac- | 20 + 110 | 18.9 (17.0) | 137.3 (20.4) | 20.4 (26.3) | 151.2 (32.6) |
| sodium + | | | | | |
| prohexadione- | | | | | |
| calcium | | | | | |
| Trinexapac- | 200 | 18.8 (15.7) | 134.0 (18.0) | 20.2 (24.7) | 148.5 (30.8) |
| ethyl | | | | | |
| Control | — | 17.5 (10.1) | 123.9 (11.4) | 19.6 (23.7) | 143.2 (28.8) |

### INDUSTRIAL UTILITY

By using the agent for increasing the sugar content of the present invention, in a cultivation area of unripe sugarcane in a broad stretch of cultivated sugarcane, ripening of such sugarcane is accelerated to control the sugar content moderately so that the large scale of facilities can be fully utilized. Furthermore, the effect of increasing the yield of sugar in sugarcane can also be achieved.

Accordingly, the present invention is effective for intensive harvest yield of a broad stretch of sugarcane cultivated area and can be employed in order to enable efficient sugar refining.

1-11. (canceled)

12. An agent for increasing the sugar content of sugarcane, which comprises at least one compound represented by the formula, 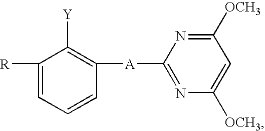
wherein A denotes an oxygen atom, sulfur atom, or hydroxymethylene group; Y denotes a free type or salt type carboxyl group, alkyloxycarbonyl group, halogenated methylsulfonylamino group or diphenylmethylideneiminoxycarbonyl group; R denotes a halogen atom, alkyl group, hydroxy-, alkoxy- or alkoxyimino alkyl group or 4,6-dimethoxypyrimidin-2-yloxy group; and Y and R may be bonded each other to form a group of —C(═O)—O—CH(CH₃)—.

13. The agent for increasing the sugar content of sugarcane according to claim 12, which comprises at least one compound selected from the group consisting of those represented by the formulae,

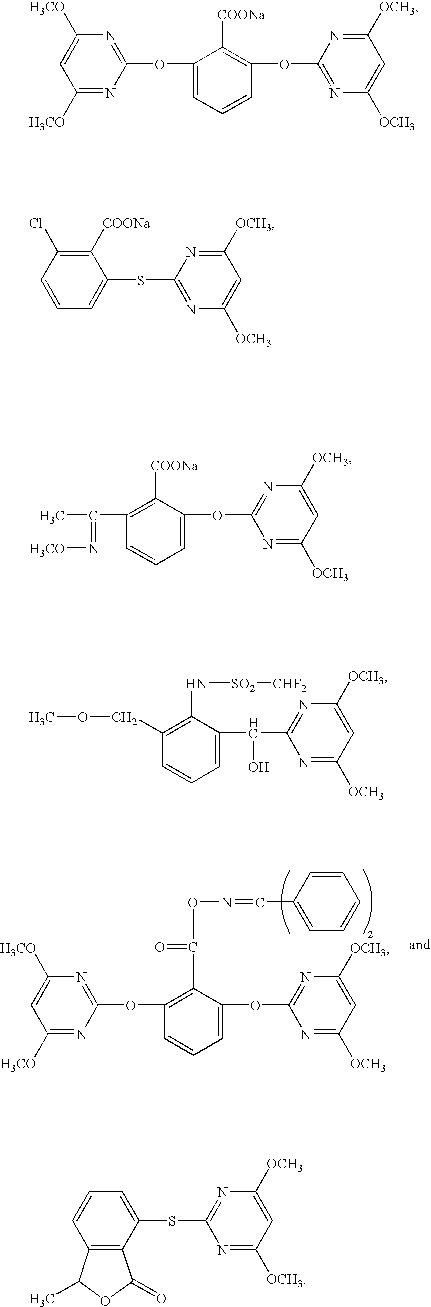

14. The agent for increasing the sugar content of sugarcane according to claim 13, which comprises a compound represented by the formula,

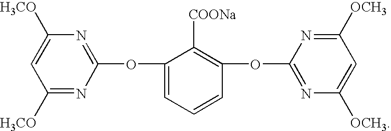

15. The agent for increasing the sugar content of sugarcane according to claim 13, which comprises a compound represented by the formula,

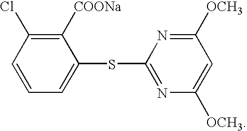

16. The agent for increasing the sugar content of sugarcane according to claim 13, which comprises a compound represented by the formula,

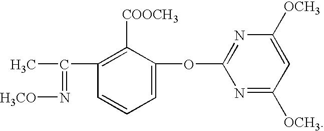

17. The agent for increasing the sugar content of sugarcane according to claim 13, which comprises a compound represented by the formula,

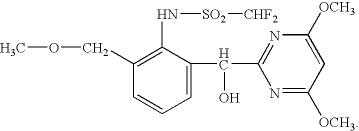

18. The agent for increasing the sugar content of sugarcane according to claim 13, which comprises a compound represented by the formula,

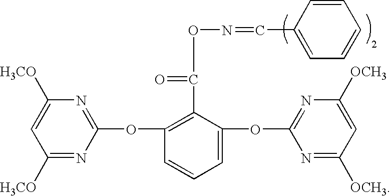

19. The agent for increasing the sugar content of sugarcane according to claim 13, which comprises a compound represented by the formula,

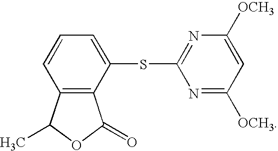

20. The agent for increasing the sugar content of sugarcane according to claim 12, which further comprises at least one compound selected from the group consisting of prohexadione, trinexapac-ethyl, gibberellins and ethephon and salts thereof, chlormequat, and mepiquat chloride.

21. The agent for increasing the sugar content of sugarcane according to claim 20, wherein the salt of prohexadione is prohexadione-calcium.

22. A method for accelerating ripening of sugarcane, which comprises applying the agent for increasing the sugar content according to claim 12 to sugarcane under cultivation 15-60 days before the harvesttime.

23. The method according to claim 22, wherein the agent is used in combination with at least one compound selected from the group consisting of prohexadione, trinexapac-ethyl, gibberellins and ethephon and salts thereof, chlormequat, and mepiquat chloride.

24. The method according to claim 23, wherein the salt of prohexadione is prohexadione-calcium.

25. The method according to claim 23, wherein prohexadione or trinexapac-ethyl is added in a dose of 10-1000 g/ha to 5-200 g/ha of the agent.

26. The method according to claim 23, wherein gibberellins is added in a dose of 0.1-1000 g/ha to 5-200 g/ha of the agent.

27. A method for accelerating ripening of sugarcane, which comprises applying the agent for increasing the sugar content according to claim 12 to sugarcane under cultivation when the concentration of a soluble solid matter (Brix) in a juice of the stem reaches 80-90% of an average Brix value of sugarcane in the harvesttime.

28. The method according to claim 27, wherein the agent is used in combination with at least one compound selected from the group consisting of prohexadione, trinexapac-ethyl, gibberellins and ethephon and salts thereof, chlormequat, and mepiquat chloride.

29. The method according to claim 28, wherein the salt of prohexadione is prohexadione-calcium.

30. The method according to claim 28, wherein prohexadione or trinexapac-ethyl is added in a dose of 10-1000 g/ha to 5-200 g/ha of the agent.

31. The method according to claim 28, wherein gibberellins is added in a dose of 0.1-1000 g/ha to 5-200 g/ha of the agent.
